(19) United States
(12) Patent Application Publication
(10) Pub. No.: US 2011/0141272 A1
(43) Pub. Date: Jun. 16, 2011

(54) APPARATUS AND METHOD FOR INSPECTING AN OBJECT SURFACE DEFECT

(76) Inventors: Sachio Uto, Yokohama (JP); Hidetoshi Nishiyama, Hitachinaka (JP); Kei Shimura, Mito (JP); Masaaki Ito, Hitachinaka (JP)

(21) Appl. No.: 13/059,523

(22) PCT Filed: Jul. 10, 2009
(86) PCT No.: PCT/JP2009/062927

§ 371 Date: Feb. 17, 2011

(30) Foreign Application Priority Data
Sep. 30, 2008 (JP) 2008-252119

(51) Int. Cl. H04N 7/18; G01N 21/956

(52) U.S. Cl. 348/135; 356/237.5; 348/E07.085

(57) ABSTRACT

Disclosed is an apparatus having a light source of a deep ultraviolet ray for detecting a small foreign matter or pattern defect, which may arise during a process for manufacturing a semiconductor device or the like, in high resolution. The apparatus comprises a means for detecting a damage on an optical system due to a wavelength reduction thereby to save a damaged portion, and a means for comparing an optical system arrangement with that at the manufacturing time and detecting the abnormality thereof, to thereby make a correction, so that the apparatus can inspect the defect on an object substrate stably at a high speed and in high sensitivity. Also disclosed is a method for the stable inspection. The apparatus is provided, in the optical path of the optical system, with a means for detecting the intensity and the convergent state of an illumination light, and a means for detecting the abnormality of the optics system and for saving an abnormal portion from alignment with an optical axis. The apparatus is constituted such that the optical system is adjusted to make corrections for the optical conditions at the manufacturing time, thereby to elongate the lifetime of the optical system in the inspecting apparatus and to detect the small defect stably.

### TECHNICAL FIELD

The present invention relates to a method and an apparatus for inspecting the situation of generation of foreign matters or defects in a device manufacturing process by detecting foreign matters existing on a thin film substrate, a semiconductor substrate, or a photomask and defects in a circuit pattern, analyzing the detected foreign matters or defects, and taking countermeasures, while semiconductor chips or liquid crystal products are manufactured.

### BACKGROUND ART

In the semiconductor manufacturing process, foreign matters which are present on a semiconductor substrate (wafer) cause faults such as an insulation fault or a shortcircuit of an interconnection. In addition, with decrease of sizes of semiconductor elements, finer foreign matters also cause an insulation defect of a capacitor or breakdown of a gate oxide film. These foreign matters are generated from movable parts of a transfer apparatus, generated from a human body, produced by reactions with process gases in the processing device, or originated as pre-mixed in chemicals or materials. In this way, foreign matters get in due to various causes in various states.

In the same way, in the manufacturing process of a liquid crystal display element as well, it becomes an element which cannot be used as a display element if a pattern defect is caused by the aforementioned foreign matters. Furthermore, the manufacturing process of a printed circuit board is also under a similar situation, and mixing in of foreign matters causes short-circuits in the patterns or defective interconnections. Against such a background, in semiconductor manufacturing, improvement in yield in semiconductor manufacturing is attempted by disposing a plurality of foreign matter inspection apparatuses on each manufacturing line in some cases and conducting feedback to the manufacturing process by finding the foreign matters earlier.

As one of conventional techniques of this kind for detecting foreign matters on a semiconductor substrate, as described in JP-A-62-89336 (Patent Literature 1), a technique for preventing a false report by irradiating the top of a semiconductor substrate with laser, detecting scattered light from foreign matters generated in the case where foreign matters adhere to the top of the semiconductor substrate, and comparing a result of the inspection with an inspection result of a semiconductor substrate of the same kind inspected immediately before, which makes possible an inspection of foreign matters and defects with high sensitivity and high reliability. Furthermore, as disclosed in JP-A-63-135848 (Patent Literature 2), a technique of irradiating the top of a semiconductor substrate with laser light, detecting scattered light from foreign matters in the case where foreign matters adhere to the top of the semiconductor substrate, and analyzing the detected foreign matters by an analysis technique such as the laser photoluminescence or the secondary X-ray analysis (XMR) is known.

Furthermore, as a technique for inspecting the aforementioned foreign matters, a method of irradiating a wafer with coherent light, removing light which emanates from a repetitive pattern on the wafer using a spatial filter, and emphasizing and detecting foreign matters and defects having no repetition is disclosed. A foreign matter inspection apparatus configured to prevent zero-th order diffracted light out of a principal straight line group from being incident in an aperture of an object lens by irradiating a circuit pattern formed on a wafer from a direction inclined by 45 degrees from the principal straight line group of the circuit pattern is known in JP-A-1-117024 (Patent Literature 3). In Patent Literature 3, it is also described to shade other straight line groups which are not a principal straight line group using a spatial filter.

As for conventional techniques concerning the defect inspection apparatus and the method for foreign matters and the like, JP-A-1-250847 (Patent Literature 4) and JP-A-2000-105203 (Patent Literature 5) are known. Especially; it is described in Patent Literature 5 to change the detection pixel size by switching the detection optic system. As a size measurement technique of foreign matters JP-A-2001-60607 (Patent Literature 6) is disclosed. In these foreign matter inspection apparatuses, high-speed and high-sensitivity inspections are required. Therefore, in developing the inspection apparatuses increase of the speed of the wafer transfer stage and the greater NA and higher resolution of the detection optic system have become important. Furthermore, there must not be adhesion of new foreign matters to an inspection object during the inspection, not to speak of preventing dust from being generated by the inspection apparatus itself.

### CITATION LIST

### Patent Literature

Patent Literature 1: JP-A-62-89836
Patent Literature 2: JP-A-63-135848
Patent Literature 3: JP-A-1-117024
Patent Literature 4: JP-A-1-250847
Patent Literature 5: JP-A-2000-105203
Patent Literature 6: JP-A-2001-60607

### SUMMARY OF INVENTION

### Technical Problem

With the progress of higher semiconductor integration, however, dimensions of foreign matters and defects to be detected are shrinking more and more, and increasing NA of the detection optic system and shortening the wavelength of inspection light have been promoted. Furthermore, even if the degree of cleanness in the inspection apparatus is improved, it requires a high cost and is substantially difficult to generate an atmosphere with foreign matters completely removed, as long as movable parts such as conveyer portions exist. And attention has not been paid to the fact that the foreign matters adhere to the surface of the optical elements because of a photo-chemical reaction between the shorter wavelength of the illumination light and with floating dust in the inspection apparatus and consequently the reflectance or transmittance of the optical elements is lowered.

### Solution to Problem

One feature of the present invention is to have a movement portion for moving optical elements one-dimensionally or two-dimensionally.

Another feature of the present invention is to have an optical detection portion and an image pickup device for measuring an illumination state of illumination light (such as an amount and a shape of illumination light).

A still another feature of the present invention is to move the optical elements by using the movement portion according to the illumination state measured by the optical detection portion and the image pickup device.

### Advantageous Effects of Invention

According to the present invention, the life of optical elements can be prolonged by moving the optical elements.

### BRIEF DESCRIPTION OF DRAWINGS

FIG. 1 is a schematic configuration diagram of a defect inspection apparatus according to a first embodiment of the present invention.

FIG. 2 comprises diagrams showing disposition relations of an illumination optic system, a schematic configuration of a low angle illumination optic system, and relations between an illumination area and a detection area in the first embodiment of the present invention.

FIG. 3 comprises oblique views of a circular conical lens and a cylindrical lens used in the illumination optic system.

FIG. 4 is a diagram for explaining an overall operation of the defect inspection apparatus.

FIG. 5 is a side view showing disposition of an orientation flat detection optic system and an end face inspection device.

FIG. 6 comprises diagrams for explaining an illumination position moving means of optical elements according to the first embodiment of the present invention.

FIG. 7 comprises diagrams for explaining an illumination position moving means of optical elements according to the first embodiment of the present invention.

FIG. 8 comprises disposition diagrams of a detector for detecting an anomaly of an optic system in the first embodiment of the present invention.

FIG. 9 comprises diagrams for explaining shape measurement of an illumination luminous flux in a second embodiment.

FIG. 10 shows detected images for judging convergence state of illumination in the second embodiment.

FIG. 11 is a diagram showing a schematic configuration for adjusting the convergence state of illumination in the second embodiment.

FIG. 12 is a schematic configuration diagram of a point image measurement optic system using transmitted light in a third embodiment.

FIG. 13 comprises diagrams showing luminance distribution of the point image in the third embodiment.

FIG. 14 is a block diagram showing a detailed configuration of a signal processing system.

FIG. 15 is a diagram for explaining a pixel merge circuit in the signal processing system.

FIG. 16 comprises diagrams for explaining the case where a convex defect is detected in the signal processing system.

FIG. 17 comprises diagrams for explaining the case where a concave defect is detected in the signal processing system.

FIG. 18 is a diagram showing a schematic configuration of a defect inspection apparatus with an observatory optic system attached thereto in a fourth embodiment.

### DESCRIPTION OF EMBODIMENTS

Hereafter, embodiments according, to the present invention will be described with reference to the drawings.

Defect inspection apparatuses according to the embodiments inspect various defects such as foreign matters, pattern defects, and microscratches on inspected substrates such as wafers in various kinds and various manufacturing processes with a high sensitivity and at a high speed, and especially stably detect defects on a surface of a thin film which is formed on a wafer surface separately from defects within the thin film. Defect inspection apparatuses according to the embodiments have a feature that they have an apparatus configuration in which the defect detection sensitivity does not vary due to decrease in reflectance and a physical change of the optic system caused by adhesion of contaminants floating in the apparatus to the surface of the optical elements.

Specifically, the defect inspection apparatuses according to the embodiments have an apparatus configuration provided with a function of detecting an anomaly in the illumination optic system and correcting the anomaly to a normal state by providing a movement portion for moving an optical element 320 and the like in an optical path of an illumination optic system 10 and detecting an illumination state with a second photodetection means 310 (an image pickup apparatus such as a TV camera) for reflecting and detecting the illumination light and a third photodetection means 180 provided on a mounting table 34 for a substrate 1 to be inspected.

Furthermore, the defect inspection apparatuses according to the embodiments can avoid a malfunction such as decrease of reflectance or transmittance of the optical element caused by adhesion of contaminants to the surface of the optical element resulting from photochemical reactions between the illumination light and the floating dust in the inspection apparatus, by detecting the malfunction with a detection means disposed in the optical path and saving the optical element with the movement portion in the case of anomaly.

In other words, the optical elements are moved by the movement portion according to the illumination state of illumination light measured by the photodetection portion.

First, embodiments of the defect inspection apparatus according to the present invention will be described specifically. In the ensuing embodiments, the case where small/large foreign matters and micro-scratches on a semiconductor wafer and on a transparent film formed on the wafer, and foreign matters and defects such as pattern defects in the transparent film are inspected will be described. However, the ensuing embodiments can be also applied to inspection of substrates of thin film substrates, photomasks, TFTs, PDPs, and hard disks, besides substrates such as semiconductor wafers.

### Embodiment 1

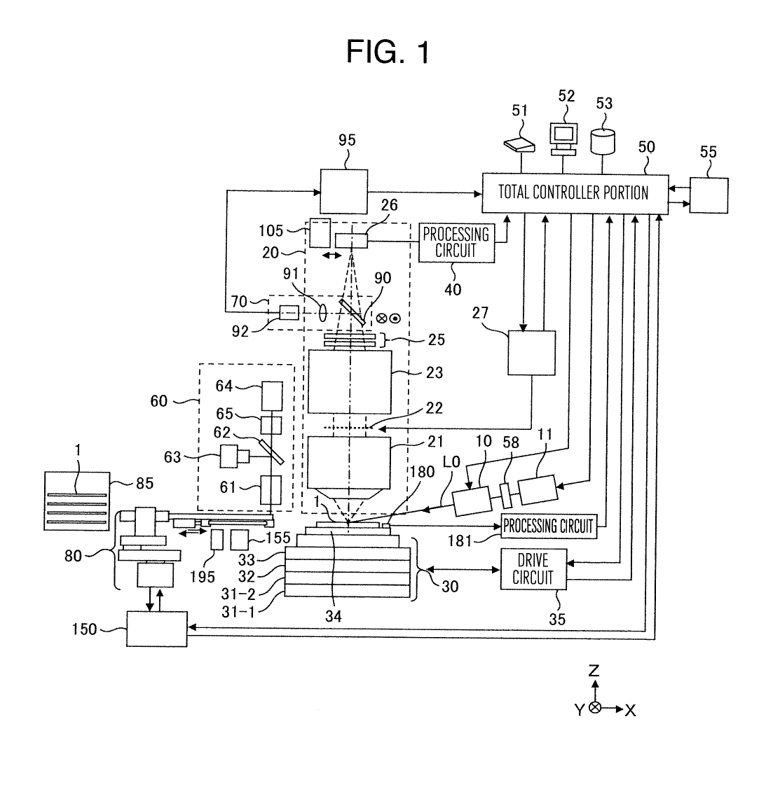

FIG. 1 shows a configuration of a defect inspection apparatus for an object surface according to a first embodiment. Broadly speaking, the present defect inspection apparatus includes an illumination optic system 10, a detection optic system 20, a conveyer system 30, a signal processing system 40, and a total controller portion 50 which controls the whole defect inspection apparatus.

The conveyer system 30 is configured to include, for example, an X stage 31-1, a Y stage 31-2, a Z stage 32, and a θ stage 33 for placing an inspection object substrate 1 such as a wafer, which is of various kinds and obtained from various manufacturing processes, on the mounting table 34 and for moving the substrate. The conveyer system 30 is configured to also include a drive circuit 35 for controlling those stages.

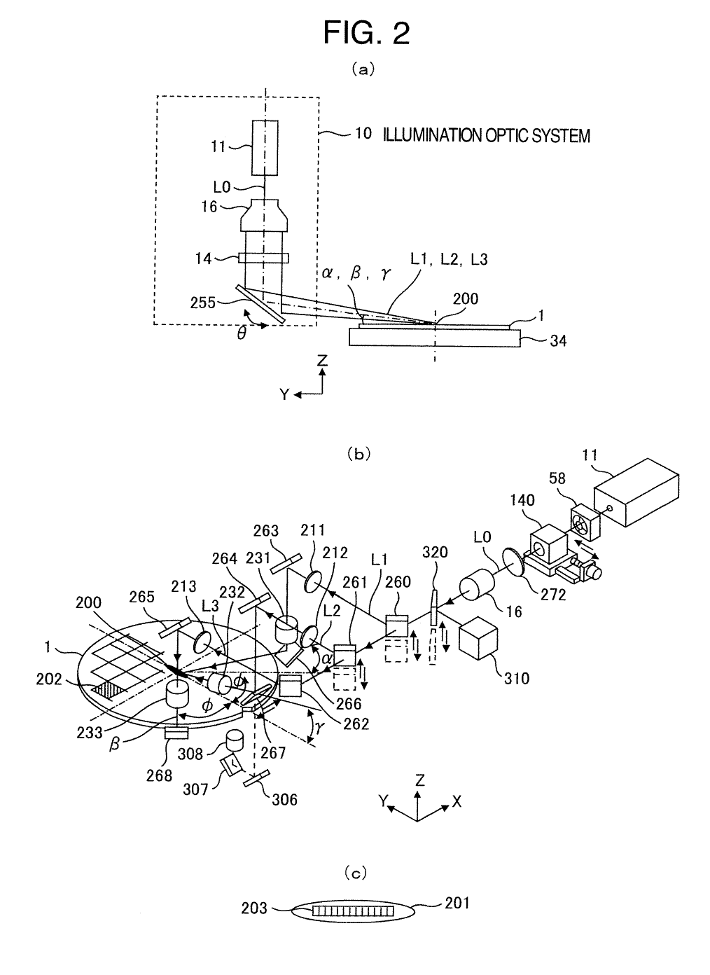

As shown in FIG. 2, the illumination optic system 10 includes, for example, a laser light source 11, a shutter 38, a beam expansion optic system 16, mirrors 260 to 268, lenses 231 to 233, and wave plates 211 to 213. The illumination optic system 10 is configured to expand the light emitted from the laser light source 11 to a certain size using a beam expansion optic system 16, and then illuminate the top of the surface of the wafer 1 from a plurality of oblique directions via mirrors, wave plates, and lenses.

The detection optic system 20 is configured to include, for example, an object lens 21, a spatial filter 22, an imaging lens 23, an optical filter 25, a mirror 90, and a photodetector 26 such as a TDI image sensor.

The signal processing system 40 conducts processing on an image signal detected by, for example, the photodetector 26 and detects defects and foreign matters.

An observatory optic system 60 includes, for example, an object lens 61, a half mirror 62, a tube lens 65, an illumination light source 63, and an image pickup means 64. The observatory optic system 60 is configured to reflect light emitted from the illumination light source 63 using the half mirror 62, bend the optical path to the direction to the wafer 1, focus the light using the object lens 61, and illuminate the surface of the wafer 1. And light which is part of light reflected and scattered by the wafer 1 and incident on the object lens 61 is transmitted through the half mirror 62 to form an image on a light receiving face of the image pickup means 64. The observatory optic system 60 confirms whether there are foreign matters and their shapes on the basis of an inspection result obtained by inspecting the wafer 1 with the detection optic system 20.

The total controller portion 50 sets inspection conditions and the like, and controls the whole of the illumination optic system 10, the detection optic system 20, the conveyer system 30, and the signal processing system 40, all of which are described above. An input/output means 51 (including a keyboard and a network), a display means 52, and a memory portion 53 are provided in the total controller portion 50. Reference numeral 55 denotes a storage means (server) for storing design data such as a circuit pattern formed on the surface of the inspection object substrate 1. A spatial optical image can be formed from the design data.

Moreover, the defect inspection apparatus includes an automatic focus control system (not illustrated) to form an image of the surface of the wafer 1 on the light receiving face of the photodetector 26. During the inspection, array pixels 203 of the photodetector 26 are controlled to be included in a linear illumination region 201.

The present inspection apparatus has a configuration in which the surface of the inspection object substrate 1 can be illuminated from a plurality of directions. A shutter 58 is opened and closed during the inspection according to whether to irradiate the surface of the inspection object substrate 1 with laser light L0. In other words, when a part other than the surface of the inspection object substrate 1 is irradiated with laser light, the shutter 58 is controlled to be closed to prevent the laser light from being led to optical elements disposed behind it. As described in JP-A-2000-105203 and as shown in FIG. 2(a), the illumination optic system 10 comprises a beam expansion optic system 16 formed of, for example, concave and convex lenses which are not illustrated, a lens 14 for shaping light L0 emitted from the laser light source 11 to a slit-shaped beam, and a mirror 255. The illumination optic system 10 shapes the light L0 emitted from the laser light source 11 to a slit-shaped (linear) beam 200 and forms a slit-shaped illumination region 201 on the wafer 1.

As a configuration for irradiating the surface of the wafer 1 with a laser beam of a single wavelength at a low angle (low incidence angle), as shown in FIG. 2(b), the inspection apparatus according to the present embodiment is configured to irradiate the wafer 1 placed on the mounting table (wafer chuck) 34 with a slit-shaped beam 200 (light with which a slit-shaped illumination region 201 of the wafer 1 is irradiated, which is hereafter referred to as “slit-shaped beam”) in a plurality of directions in a plane (irradiation directions of laser light L1, L2 and L3 in FIG. 2(b)) and at a plurality of irradiation angles (α, β and γ in FIG. 2(b)).

The reason why the illumination light is formed as the slit-shaped beam 200 is that it is attempted to make the speed of the foreign matter inspection faster by forming an image of scattered light from foreign matters or defects generated by the illumination on the detection face of the light receiving elements arranged in a line of the photodetector 26 and detecting collectively.

In other words, the direction of the wafer 1 placed on the mounting table 34 is adjusted by driving the θ stage 33 to make the arrangement direction of a chip 202 formed on the wafer 1 parallel to a scanning direction of the X stage 31-1 and a scanning direction of the Y stage 31-2. The top of the wafer 1 adjusted in direction is irradiated with the slit-shaped beam 200.

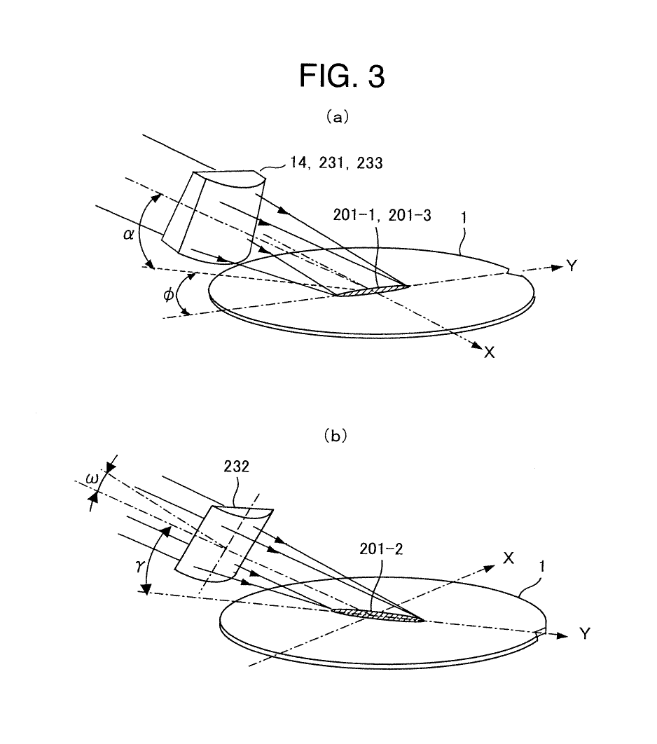

As for the shape of the slit-shaped illumination region 201 on the wafer irradiated with the slit-shaped beam 200, the optical axis is adjusted to be perpendicular to the scanning direction X of the X stage 31-1 (the longitudinal direction of the slit-shaped illumination region 201 irradiated on the wafer 1 is perpendicular to the scanning direction X of the X stage 31-1), be parallel to the scanning direction Y of the Y stage 31-2 (the longitudinal direction of the slit-shaped illumination region 201 irradiated on the wafer 1 is parallel to the scanning direction Y of the Y stage 31-2), and be parallel to the direction of the pixel array 203 of the photodetector 26 as well, by an optic system configured to focus light in the X direction and form parallel rays in the Y direction. When comparing the image signal between chips, this brings about an effect that position alignment between the chips is facilitated. The slit-shaped illumination region 201 can be formed by providing, for example, the circular conical lens 14 or a cylindrical lens 232 in the optical path as shown in FIG. 3. For example, the lenses 231 and 233 are circular conical lenses having a continuously changing radius of curvature in the longitudinal direction as shown in FIG. 3(a). The major axis direction of the slit-shaped beam 201 with which the top of the wafer 1 is irradiated from a direction of ø in the horizontal direction is made parallel to the scan direction of the Y stage 31-2.

In other words, in the illumination using the laser light L1 and L3, the top of the wafer 1 is irradiated with laser light shaped in a slit form from directions obtained by rotating to the left and right by the angle ø with respect to the Y axis direction of the wafer and inclining by the angle α in the Z axis direction (in FIG. 2(b), an optical path on which illumination light from L3 is reflected by a mirror 265 and transmitted by the lens 233 to arrive at the mirror 268 and an optical path from the mirror 268 to the irradiation region 201 of the slit-shaped beam 200 on the wafer 1 are shown to be overlapped), respectively.

As for the illumination using the laser light L2, an irradiation region 201-2 of the slit-shaped beam 200 is formed in the same direction as the scanning direction of the Y stage 31-2 from a direction inclined by an angle γ with respect to the Y axis of the wafer by, for example, the cylindrical lens 232 shown in FIG. 3(b) (the cylindrical lens 232 is disposed to be inclined with respect to the Y axis and focus the irradiation region 201-2 of the slit-shaped beam 200 on the wafer 1).

The illumination angle α (β, γ) can be changed according to, for example, the kind of inspection object foreign matters on the inspection object substrate 1 by changing the angle θ of the mirror 255 as shown in FIG. 2(a) using a drive means such as a pulse motor, which is not illustrated, on the basis of a command given by the total controller portion 50. As shown in FIG. 2(c), the irradiation region 201 of the slit-shaped beam 200 is adapted to cover the pixel array 203 of the photodetector 26 no matter what value the illumination angle assumes. No matter which of laser light L1, L2 and L3 is used for illumination, irradiation regions 201-1 to 201-3 of the slit-shaped beam 200 are adapted to coincide with each other on the wafer 1.

As a result, illumination having parallel rays in the Y direction and ø which is approximately 45 degrees can be implemented. Especially, by forming the slit-shaped beam 200 as parallel rays in the Y direction, diffracted light generated from a circuit pattern in which principal straight line groups are directed in the X direction and Y direction is shielded efficiently by the spatial filter 22. Here, as shown in FIG. 1, the spatial filter 22 is adjusted to shield luminous spots by the use of a shield plate having a plurality of rectangular shaped shield parts provided in the image forming position of Fourier transform, by picking up an image of the luminous spots of a reflected/diffracted light image from a repetitive pattern in the image forming position of the Fourier transform by the use of a pupil observatory optic system 70 formed of a mirror 90 which can be saved in the Y direction during the inspection, a projection lens 91, and a TV camera 92 in the optical path of the detection optic system 20, and conducting processing in a processing circuit 95.

These operations are conducted by signals from the drive circuit 27 on the basis of commands from the total controller portion 50. For example, if the circuit pattern formed on the inspection object substrate 1 is high in density, a high density inspection mode with a high magnification is set whereas if the circuit pattern is low in density, fast inspection is conducted with a low magnification. In this way, the illumination and detection conditions are set to detect a large number of minute defects according to the surface information and manufacturing process of the inspection object substrate 1.

Furthermore, as the laser light source 11, for example, a high output laser having a YAG second harmonic wavelength of 532 nm or a fourth harmonic of 266 nm may be used. The laser light source 11 may be an ultraviolet, far ultraviolet, or vacuum ultraviolet laser. Also, the laser light source 11 may be a light source such as an Ar laser, a nitrogen laser, a He—Cd laser, an excimer laser, or a semiconductor laser.

In general, by making the wavelength of the laser short, the resolution of the detected image is improved and consequently a high sensitivity inspection becomes possible.

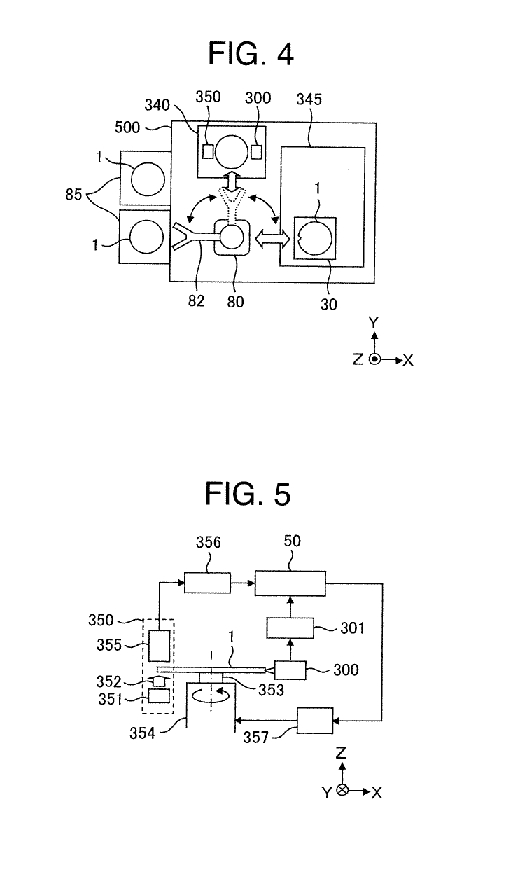

An example of operation of defect inspection on an object surface in the present invention will now be described with reference to FIG. 4. In FIG. 4, reference numeral 500 denotes a defect inspection apparatus, 85 a wafer cassette for housing a wafer, 80 a transfer robot, 82 a transfer arm for grasping and transporting a wafer, 340 a wafer orientation flat detection portion, 350 an orientation flat detection optic system, 300 an end face inspection device for detecting defects in a wafer edge part, and 345 a defect inspection device for detecting defects on the wafer surface. The wafer 1 which is the inspection object substrate is taken out from the wafer cassette 85 by the transfer arm 82, and transported to the orientation flat detection portion 340. FIG. 5 is a sectional view obtained by viewing the orientation flat detection portion 340 from the Y direction in FIG. 4. The wafer 1 is vacuum-adsorbed to a chuck 353, and rotated by a motor 354. The orientation flat detection optic system 350 comprises, for example, a light projection portion 351 and a detection portion 355. Illumination light 352 from the light projection portion 351 is received, and a received light signal in the detection portion 355 is sent to the total controller portion 50 through a processing circuit 356. The total controller portion 50 calculates an amount of eccentricity of the wafer 1 and an orientation flat (V notch) position, and sends an orientation flat correction signal with respect to the Y axis to the motor 354 via a controller 357. The amount of eccentricity is fed back to a movement value of the transfer arm 82 as a correction value when the transfer robot places the wafer 1 on the conveyer system 30 in the defect detection portion 345, and the wafer 1 is aligned in position with the center of the mounting table 34 in the defect detection portion 345. On the other hand, while the wafer 1 is rotating, the end face inspection device 300 conducts defect inspection on an end face part (edge part) of the wafer 1. A detected signal is processed in a processing circuit 301 and a defect signal is sent to the total controller portion 50. If a defect is detected, then its coordinate position in the rotation direction with the position of the orientation flat taken as an origin position is stored in the total controller portion 50 on the basis of a pulse count of a rotary encoder which is not illustrated and which is coupled to the motor 354.

In the defect inspection, it is necessary to inspect minute defects on the surface of the wafer 1 at high speed. In addition, there are various kinds of defects on the surface of the wafer 1 placed on the mounting table 34 in the defect inspection portion 345. In the defect inspection, it is demanded to detect defects of as many types as possible in a stable manner. Therefore, it is necessary to set inspection conditions conformed to types of defects to be detected. The present defect inspection apparatus has a configuration in which the illumination direction and angle can be changed according to the types of defects, and has an apparatus configuration in which inspection can be conducted under determinate inspection conditions. In other words, the present defect inspection apparatus has an amount of illumination light monitor and an illumination beam shape confirmation function, and the illumination conditions are set to become optimum. In semiconductor inspection, increasing the NA of the detection optic system and shortening the wavelength of the illumination light have been promoted to detect more minute defects. On the other hand, in wavelength shortening of illumination light, transmitting glass materials are restricted and foreign matters floating in air adhere to the optic system. Irradiation of the floating foreign matters which adhere to the optic system with illumination light causes a chemical change. As a result, transmittance and reflectance of the optic system decrease, resulting in a problem that the defect inspection cannot be conducted stably.

In the present embodiment, therefore, the amount of light and shape of the illumination beam are measured in the defect inspection apparatus. If the transmittance is judged to decrease due to contamination of the surface of the optical element such as a mirror or a filter disposed in the optical path, the optical element such as the mirror or the filter is moved in a one-dimensional or two-dimensional direction to prevent the part of decreasing transmittance from being irradiated with the illumination light.

In the measurement of the amount of light and shape of the illumination beam, a detector 180-1 or 180-2 in a second embodiment described later may be used, or the mirror 320 (shear plate) or the TV camera 310 may be used.

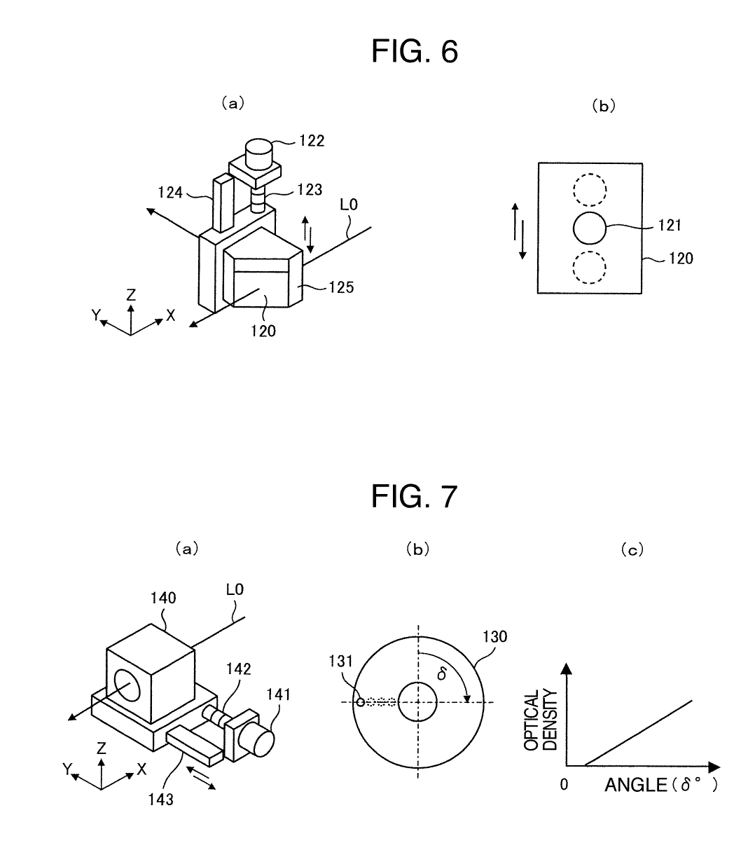

Examples of the movement portions which move the optical elements and movement methods will now be described with reference to FIG. 6 and FIG. 7. An optical element decreased in transmittance or reflectance by dirt, damage, or the like on the surface is configured to move in a plane direction perpendicular to the optical axis L0 to prevent the optical axis from shifting at the time of movement. FIG. 6 shows an example of the movement portion for moving a beam splitter (or mirror) 120. The beam splitter (or mirror) 120 supported by a holder 125 is moved in a direction perpendicular to the optical axis L0 and a vertical direction on the paper by a motor 122, a feed screw 123 and a linear guide 124 as shown in FIG. 6(b) to move an irradiation position of an illumination beam 121 (dashed line parts). Here, the motor 122 drives the feed screw 123. The feed screw 123 is moved by rotation of the motor 122 to move the optical element. The linear guide 124 is a member such as a rail which prescribes the movement direction of the optical element.

If the diameter of the illumination beam is sufficiently small as compared with the reflection face (transmission face) of the beam splitter 120, then a small amount of movement quantity suffices. The movement quantity is set in advance according to the diameter of the illumination beam. In addition, it is also possible to move the irradiation position of the illumination beam relative to the mirror in a two-dimensional direction by providing a movement mechanism in the X-Y direction to conduct shift correction of the optical axis after the mirror movement. Furthermore, it is possible to rotate a circular variable ND filter 130 having characteristics shown in FIG. 7(c) or a polarizer by using a movement portion shown in FIG. 7(a). In other words, the position irradiated with the illumination beam should be changed by moving an optical unit 140 having the ND filter or polarizer provided therein in a direction perpendicular to the optical axis of laser light (in a left and right direction on the paper) (dashed line parts) using a motor 141, a feed screw 142, and a linear guide 143. Moreover, the movement quantity of the optical element is calculated in advance on the basis of the beam diameter 121 (or 131) of the illumination beam L0, and a movement quantity which does not interfere with the damaged part is set by a command given by the total controller portion 50. By the way, if a place to be moved to runs out, the optical element is replaced by a new one. In this case, the optical unit may be replaced by a spare optical unit. Or a configuration in which another set of similar optical elements is installed on the optical unit and moved on the linear guide by the motor and the feed screw to change over may be used.

Besides, it suffices that the movement portion for moving the optical element in the present embodiment has a configuration capable of moving the optical element in the optical path. The movement portion can be applied to various inspection apparatuses having a possibility that contamination of the optical elements will occur. As one example, the movement portion can be applied to a pattern-less wafer surface inspection apparatus as well. For example, the conveyer system 30 may have a configuration to conduct rotation movement and straight advancing movement. The detection optic system 20 may use a photomultiplier tube (PMT) or the like besides the TDI image sensor. The spatial filter 22 may be omitted.

### Embodiment 2

Incidentally, for detecting minute defects on a highly integrated semiconductor substrate at a high speed, it is necessary to irradiate the top of the wafer 1 with a high luminance illumination beam and detect scattered light generated from a defect efficiently. Therefore, it is desirable that the irradiation region 201 of the slit-shaped beam 200 coincides on the wafer 1 with the pixel array of the photodetector 26 and the luminance distribution of the slit-shaped beam 200 takes, for example, a shape in line with the luminance distribution of the laser. During the inspection, an automatic focus system which is not described exercises control to provide the surface of the wafer 1 with a constant height with respect to an object focus of the detection optic system 20. Therefore, the irradiation region 201 of the slit-shaped beam 200 is maintained in a state in which it coincides on the wafer 1 with the pixel array of the photodetector 26. If the irradiation position of the illumination beam on the wafer or a beam shape (profile) is changed by a change of the optic system with the passage of time or a shift of crystal for UV light conversion provided within the laser light source 11 (which is executed automatically or manually on the laser light source side when crystal surface is subjected to damage such as burning by laser irradiation and the output power decreases), however, it becomes impossible to conduct stable defect inspection.

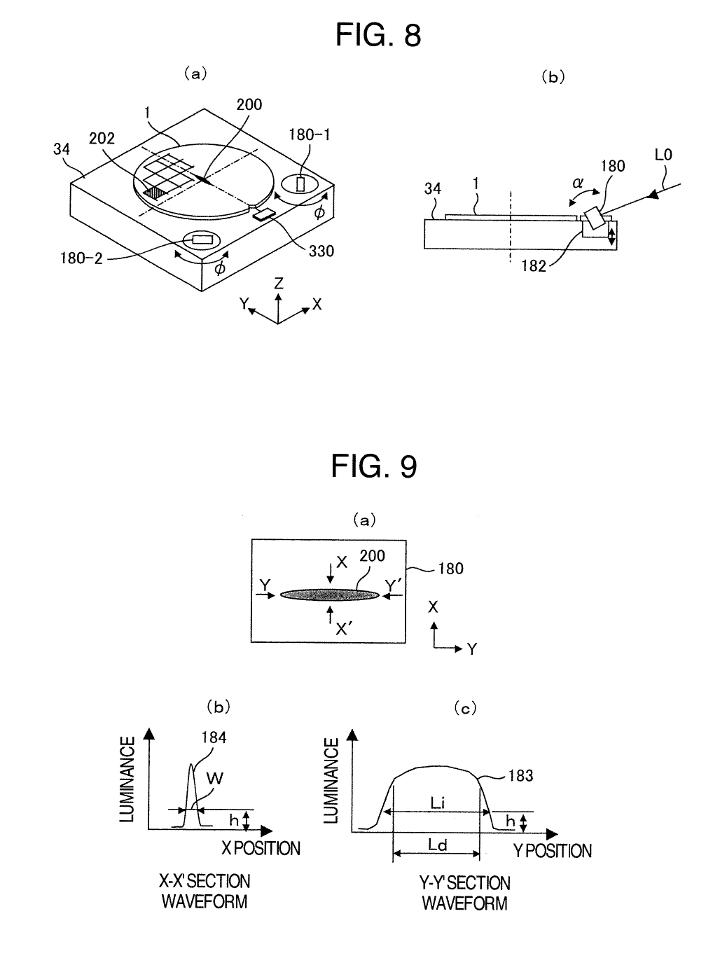

As a second embodiment of the present invention, therefore, a method for detecting an anomaly of the shape of the illumination beam and correcting it will now be described. In order to detect the state of the illumination beam, in the present invention, a means of measuring illumination beam shape is provided near the wafer 1 on the mounting table 34 and the shape of the illumination beam is measured and corrected. In other words, as shown in FIG. 8(a), detectors 180-1 and 180-2 are disposed symmetrically in the irradiation routes of laser light L1 and L3 to the wafer 1 on the mounting table 34 to make the shape of the illumination beam measurable. FIG. 8(b) is a side view obtained by seeing from the X direction. The detector 180 is held on a holder 182 and configured to be rotatable in a direction and an a direction and movable in the Z direction as a whole of the detector. Here, and a are set to cause laser light L1, L2 and L3 incident onto the detector 180 to be incident onto and perpendicular to a light receiving face of the detector 180. The detector 180 is, for example, a slit scanning type detector or a CCD sensor having two-dimensionally arranged light receiving elements. And the detector 180 has a configuration in which it is housed within the mounting table 34 and it does not protrude from the inspection face of the wafer 1 except at the time of profile measurement.

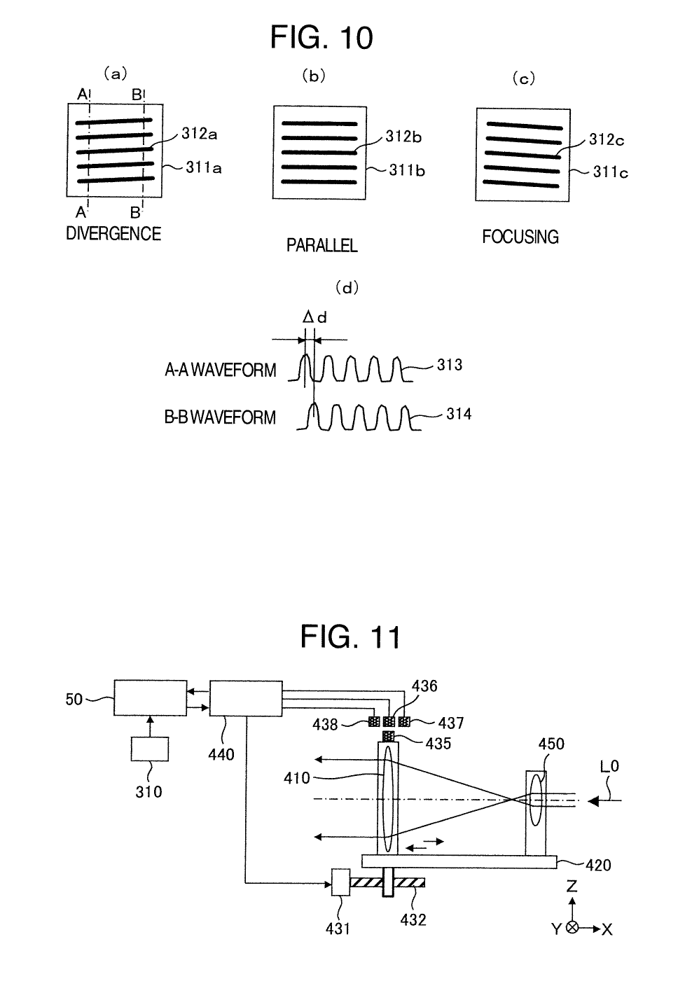

A method of finding the profiles of the laser light L1 to L3 with which the top of the wafer 1 is irradiated will now be described. FIG. 9(a) is a schematic diagram showing a detection state of the illumination beam detected by the detector 180. A detected signal of the detector 180 is sent to the total controller portion 50. The total controller portion 50 finds an X-X′ direction sectional waveform 184 and a Y-Y′ direction sectional waveform 183 from a detected image of the slit-shaped beam 200, calculates a width W and a length L of the slit-shaped beam 200 at a position of an arbitrary set value h, collates them with data stored in the storage means 55 beforehand, and determines whether the width the beam profile is within an allowable range. If it is outside of the allowable range, the condenser lens 231 or 233 is moved in the optical axis direction by a drive means which is not illustrated and adjustment is conducted to bring the width W and the length L of the slit-shaped beam 200 into the allowable range. If it can not be adjusted within the allowable range at this time, it is considered that collimation of the laser light emitted from the beam expander 16 is not favorable. Operation for adjusting the collimation of the beam expander 16 will now be described. In an example of a configuration according to the present invention, the mirror 320 configured to be savable is disposed in the optical path near an exit port of the beam expander 16 and a plane wave reflected by the mirror 320 is received by the TV camera 310 to measure the parallelism of the laser beam on the basis of the state of interference fringes. In other words, the mirror 320 is a shear plate polished on its obverse and reverse with high precision, and reflected light from the obverse and reflected light from the reverse overlap each other in the X direction to form interference fringes. FIG. 10(a) to (c) are schematic diagrams of the interference fringes detected by the TV camera 310, which show a state in which the direction of interference fringes change according to the convergence state of laser light emitted from the beam expander 16. A detected image 311 of the TV camera 310 is sent to the total controller portion 50.

In order to calculate the rotation angle of the interference fringes from the detected image, the total controller portion 50 generates an A-A section waveform 313 and a B-B section waveform 314, calculates a phase difference Δd between those waveforms, adjusts a lens spacing of the beam expander 16 on the basis of a result of the calculation, and conducts adjustment to cause the laser light to become parallel rays. FIG. 11 is a diagram showing a schematic configuration of the beam expander 16. The beam expander 16 is formed of two groups of lenses, i.e., a lens 410 and a lens 450, and the lens 450 is fixed to a guide 420. The lens 410 is configured to be moved on the guide 420 in the X direction by a motor 431 and a feed screw 432. The lens 410 moves in the X direction between limit sensors 437 and 438 with a position of an origin sensor 436 taken as a reference origin, and parallelism of laser light emitted from the beam expander 16 changes. The total controller portion 50 adjusts the spacing between the lens 410 and the lens 450 while driving the motor 431 via a controller 440 to minimize the phase difference Δd calculated from the image 311 taken in from the TV camera 310. When the parallelism of the laser light has become equal to or less than a preset allowable value, the total controller portion stops drive of the motor 431, and stores the X-direction position of the lens 410 (the number of pulses from the reference origin) in the memory portion 53.

According to the method in the present embodiment, an anomaly of the shape of the illumination beam can be detected and corrected. As a result, stable defect inspection can be conducted.

### Embodiment 3

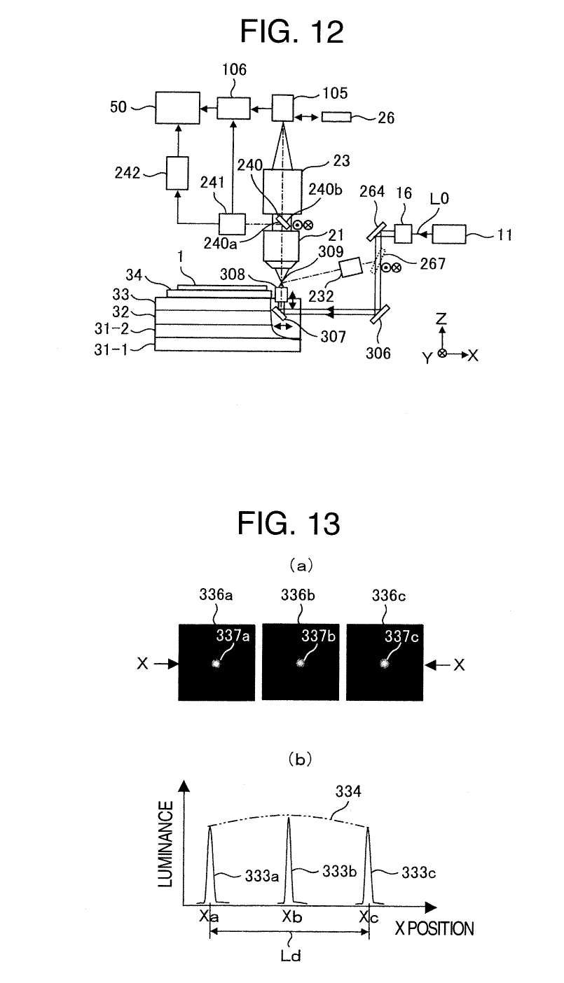

A method for detecting and correcting an anomaly of the detection optic system will now be described with reference to FIG. 12 and FIG. 13. The detection optic system 20 in the present defect inspection apparatus is a telecentric optic system formed of the object lens 21 and the imaging lens 23. For detecting defects stably in defect inspection, it is desirable that the performance of the detection optic system does not change from that at the time of manufacture. In the present invention, therefore, means for confirming the imaging performance of the detection optic system are provided on the way of the optical path and in the imaging position of the detection optic system.

In other words, as shown in FIG. 12, in a state in which a mirror 267 is saved in the Y direction, parallel laser light L0 emitted from the laser light source 11 is expanded by the beam expander 16, then a laser spot (point image) is formed in an object point position of the detection optic system 20 by a condenser lens 308 via mirrors 264, 306 and 307, and imaging performance is checked on the basis of a shape of a point image in the imaging position of the detection optic system 20. Laser light which has passed through the condenser lens 308 is focused, then spread, incident on the object lens 21, and become a parallel luminous flux. Then, the laser light traces an optical path in which it is reflected by a mirror 240 installed between the object lens 21 and the imaging lens 23 and it arrives at a TV camera 241. Or the laser light traces an optical path in which it advances straight with the mirror 240 saved in the Y direction and it is incident on the imaging lens 23.

The light incident on the imaging lens 23 forms an image on a light receiving plane of a TV camera 105 which is disposed to be the same in position of light receiving plane as the detector 26 disposed over the imaging lens 23 and which is installed to be switchable with the detector 26 in the X direction. The condenser lens 308 is mounted on an XYZ stage which is not illustrated. The condenser lens 308 is moved in the Z direction to cause a laser spot 309 to be located on the optical axis of the object lens 21 and coincide with a focal point (a position where a point image 337 of a detected image of the TV camera 105 is minimized). In this way, the imaging position is determined.

The mirror 240 inserted between the object lens 21 and the imaging lens 23 is a shear plate polished on both sides, i.e., an obverse 240a and a reverse 240b with high precision. Light reflected by the obverse of the mirror 240 and light reflected by the reverse of the mirror 240 overlap each other, and interference fringes are projected onto a light receiving plane of the TV camera 241. An output of the TV camera 241 is sent to the total controller portion 50 via an image input substrate 242. The total controller portion 50 moves the condenser lens 308 in the Z direction to cause inclinations of the interference fringes to become parallel by the method described with reference to FIG. 10 and conducts adjustment.

A method for checking the imaging performance in a visual field range of the detection optic system using the point image 309 will now be described. In the state in which the mirror 240 is saved in the Y direction, the laser spot 309 is moved in the object point position of the detection optic system 20 and the laser spot image 337 is detected by the TV camera 105. The laser spot 309 is moved by moving the condenser lens 308 and the mirror 307 simultaneously. In other words, while the laser spot 309 is moved to Xa to Xc, the TV camera 105 is also moved in synchronism and laser spot images 337a to 337c are detected. The movement quantity of the TV camera 105 is found from the movement quantity of the laser spot 309 and a magnification of the detection optic system 20. FIG. 13 shows cross-sectional waveforms (luminance maximum values) of laser spot images (337a to 337c) of detected images (336a to 336c) of the TV camera 105 at a section C-C when the X direction position of the laser spot 309 is Xa, Xb, and Xc in a detection visual field Ld of the detection optic system 20. Intensity distribution 334 is found from peaks of section waveforms of spot images. The intensity distribution 334 found here is referred to in collation with data stored in the server 55 at the time of production of the detection optic system and in correlative collation with the luminance distribution 183 of illumination in the detection visual field Ld. For example, a gain of each pixel in the TDI sensor 26 is adjusted and sensitivity correction is conducted in the whole region of the detection visual field Ld, resulting in an effect in stable detection of defects.

Moreover, means for moving the optical elements such as the mirror 267, the mirror 240, the condenser lens 308, and the mirror 307 and the TV camera 105 may be a mechanism using the motor 122, the feed screw 123, and the linear guide 124 described in the embodiment 1, or may be an air cylinder.

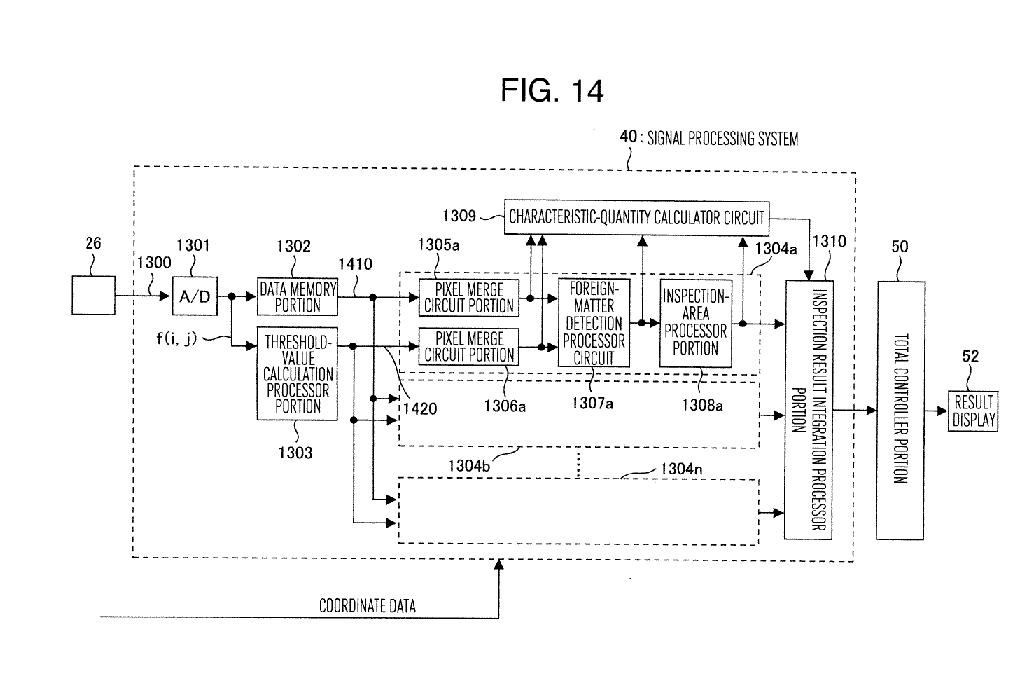

Defect detection signal processing in the defect inspection apparatus will now be described. FIG. 14 shows a configuration of a signal processing system according to the present invention. A detected image signal 1300 obtained by receiving reflected/diffracted light from the surface of the wafer 1 and conducting photoelectric conversion in the photodetector 26 is processed in the signal processing system 40. The signal processing system 40 comprises an converter 1301, a data memory portion 1302 for storing a detected image signal f(i, j) 1410 obtained by conducting conversion, a threshold-value calculation processor portion 1303 for conducting threshold-value calculation processing on the basis of the detected image signal, foreign-matter detection processor portions 1304a to 1304n having a plurality of circuits to conduct foreign matter detection processing for every pixel merge on the basis of detected image signal 1410 obtained from the data memory portion 1302 and threshold-value image signals (Th(H), Th(Hm), Th(Lm), Th(L)) 1420 obtained from the threshold-value calculation processor portion 1303, a characteristic-quantity calculator circuit 1309 for calculating characteristic quantities such as an amount of scattered light and the number of detected pixels indicating the size of a defect, which are obtained from a detected defect using low angle and high angle illumination, and a integration processor portion 1310 for classifying the size and type of a defect or a foreign matter on the basis of the characteristic quantity of every merge obtained from the characteristic-quantity calculator circuit 1309.

Each of the foreign-matter detection processor portions 1304a to 1304n comprises, for example, pixel merge circuit portions 1305a to 1305n and 1306a to 1306n including a merge operator 1504 to conduct image processing on the detected two-dimensional image with 1×1, 3×3, 5×5, . . . n×n pixels taken as the unit, foreign-matter detection processor circuits 1307a to 1307n, and inspection-area processor portions 1308a to 1308n.

The detected image signal f(i, j) 1410 digitized by the A/D converter 1301 is sent to the data memory portion 1302 and the threshold-value calculation processor portion 1303. The threshold-value calculation processor portion 1303 calculates the threshold-value image Th(i, j) 1420 for detecting defects and foreign matters from the detected image signal, and outputs it to the pixel merge circuit 1306. The pixel merge circuits 1305 and 1306 have a function of coupling in the range of n×n pixels on the image signals 1410 and 1420 which are output from the data memory portion 1302 and the threshold-value calculation processor portion 1303, respectively. The pixel merge circuits 1305 and 1306 are circuits which output, for example, an average value of n×n pixels, and image processing is conducted in each of the various merge operators. The foreign-matter detection processor circuit 1307 conducts processing on signals which are output from the pixel merge circuits 1305 and 1306, and detects defects and foreign matters. The pixel merging is conducted for the purpose of detecting defects and foreign matters which exist on the wafer 1 and which differ from each other in size, with high S/N by using detection pixels conformed to its size, Owing to the shape of the defect to be detected, however, it is not always necessary that the size is n×n, but it may be n×m.

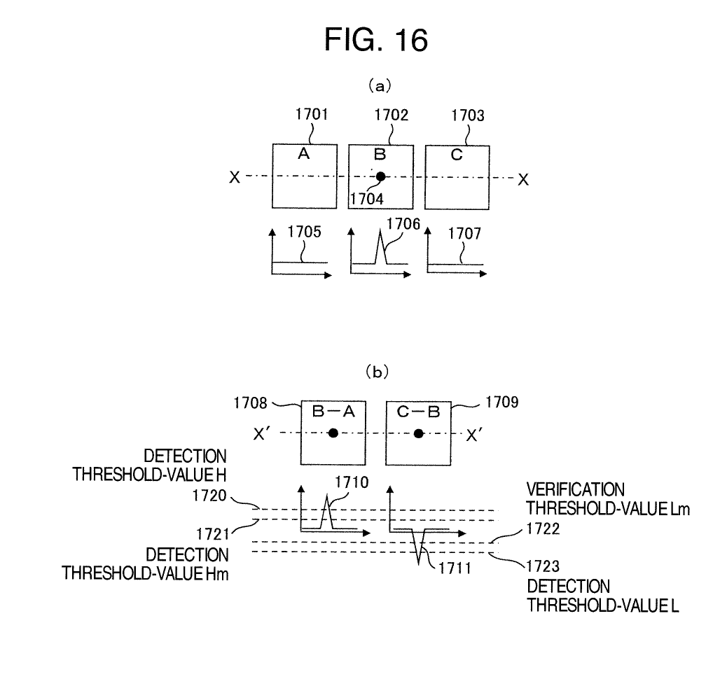

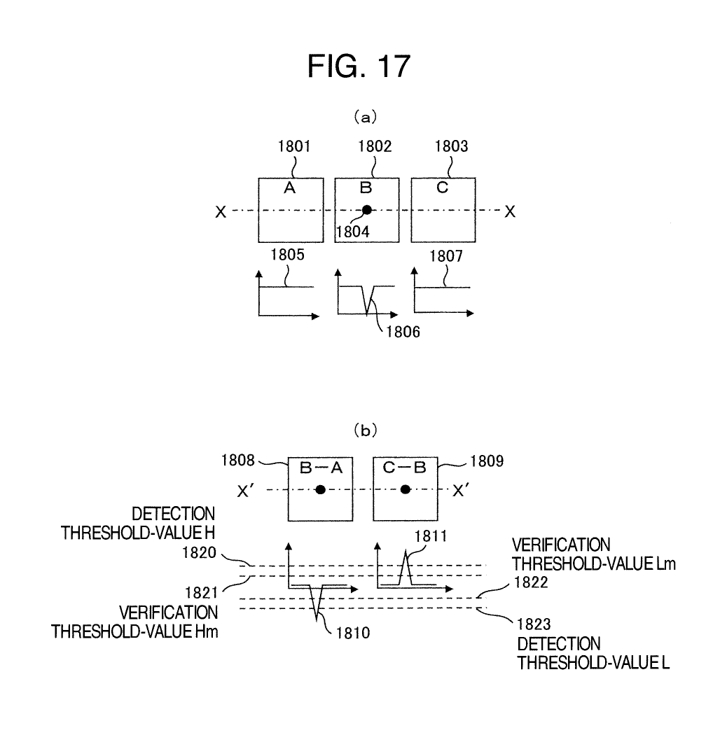

The inspection-area processor portion 1308 conducts processing for identifying a chip having a defect or a foreign matter detected by the foreign-matter detection processor circuit 1307. A detection threshold-value Th(H, L) and a verification threshold-value Th(Hm, Lm) are provided for detecting a defect or a foreign matter, and a chip having the detected foreign matter or defect is identified. FIG. 16(a) shows an example of the detected image in case where a convex shaped defect 1704 exists in a center chip 1702 among chips 1701, 1702 and 1703 and signal waveforms at a section X-X. Also, FIG. 17(a) shows an example of the detected image in case where a concave shaped defect 1804 exists in a center chip 1802 among chips 1801, 1802 and 1803. In FIG. 16(a), a signal 1706 represents a signal of the convex defect 1704, whereas a signal 1705 and a signal 1707 represent the case where there are no defects in the chip.

FIG. 16(b) shows a result of difference processing with adjacent chips taken as the unit. Difference signals 1710 and 1711 represent signal waveforms at a section X′-X′ of difference images 1708 and 1709 of image signals obtained in the chips 1701, 1702 and 1703, The difference signal 1710 is a difference signal between an image signal “B” of the chip 1702 and an image signal 1″A″ of the chip 1701 (B-A). The difference signal 1711 is a difference signal between an image signal “C” of the chip 1703 and the image signal “B” of the chip 1702 (C-B). Here, the detection threshold-value H and the verification threshold-value Hm are threshold-values for detecting a convex shaped difference signal, and the detection threshold-value L and the verification threshold-value Lm are threshold-values for detecting a concave shaped difference signal.

In FIG. 16(b), if the difference signal 1710 (B-A) is positive and its value is greater than the detection threshold-value H or the verification threshold-value Hm, it is detected as a foreign matter or a defect. If the difference signal 1711 (C-B) is negative and its value is less than the detection threshold-value L or the verification threshold-value Lm (in this case, the signed value is less than the threshold-values because both the difference value and the threshold-values are negative values, but the difference value is greater than the threshold-values in absolute values), it is detected as a foreign matter or a defect.

Moreover, an adjacent chip does not exist at the time of inspection of an outer periphery of the wafer 1. In this case, the inspection-area processor portions 1308a to 1308n switch comparison processing {(B-A), (C-B)} between the adjacent chips described above to comparison processing {(B-A), (C-A)} between adjacent chips with skip on the basis of inspection coordinate data obtained from the total controller portion 50.

The inspection-area processor portion 1308 conducts processing depending upon a detection location on the detected foreign matter signal and the threshold-value image. At the same time, the characteristic-quantity calculator circuit 1309 calculates characteristic quantities (for example, an amount of scattered light obtained by high angle illumination, an amount of scattered light obtained by low angle illumination, and the number of detection pixels of a defect, and so on) on the basis of signals obtained from the pixel merge circuits 1305a to 1305n and 1306a to 1306n, the foreign-matter detection processor circuits 1307a to 1307n, and inspection-area processor portions 1308a to 1308n in the foreign-matter detection processor portions 1304a to 1304n provided in each merge operator of various kinds. The integration processor portion 1310 unifies the foreign matter signal and the characteristic quantities and transmits unified data to the total controller portion 50.

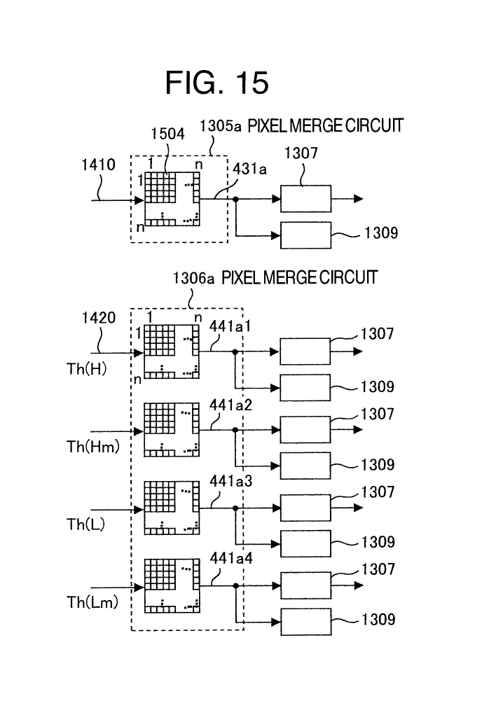

Hereafter, details will be described. The A/D converter 1301 is a circuit for converting the analog signal 1300 obtained by the photodetector 26 to a digital signal having 8 to 12 bits. The data memory portion 1302 is a circuit for storing the digital signal obtained by the A/D conversion. The pixel merge circuit portions 1305a to 1305n and 1306a to 1306n comprise respectively different merge operators 1504 shown in FIG. 15.

The merge operator 1504 has a function of combining in the range of n×n pixels each of the detected image signal f(i, j) 1410 obtained from the data memory portion 1302 and the difference threshold-value image signal 1420 comprising the detection threshold-value image Th(H), the detection threshold-value image Th(L), the verification threshold-value image Th(Hm), and the verification threshold-value image Th(Lm) which are obtained from the threshold-value calculation processor portion 1303. The merge operator 1504 is a circuit for outputting, for example, an average value of n×n pixels.

Here, as for the pixel merge circuit portion, for example, 1305a and 1306a are formed of merge operators which merge 1×1 pixel, 1305b and 1306b are formed of merge operators which merge 3×3 pixels, 1305c and 1306c are formed of merge operators which merge 5×5 pixels, and 1305n and 1306n are formed of merge operators which merge n×n pixels, all of which merge an odd number of pixels. For example, the merge operator which merges 1×1 pixel outputs the input signal 1410 or 1420 as is.

Since the threshold-value image signals comprise image signals of four kinds (Th(H), Th(Hm), Th(Lm), and Th(L)), each of the pixel merge circuit portions 1306a to 1306n also requires the merge operators Op of the aforementioned four kinds. Therefore, each of the pixel merge circuit portions 1305a to 1305n conducts merge processing on the detected image signal in the merge operator 1504 and outputs results as merge processing detected image signals 431a to 431n. On the other hand, each of the pixel merge circuit portions 1306a to 1306n conducts merge processing on the four threshold-value image signals (Th(H), Th(Hm), Th(Lm), and Th(L)) in the merge operators Op1 to Opn of each kind and outputs results as merge processing threshold-value image signals 441a (441a1 to 441a4) to 441n (441n1 to 441n4). Moreover, merge operators in each of the pixel merge circuit portions 1306a to 1306n are the same.

An effect obtained by merging pixels will now be described. In the foreign matter inspection, it is necessary to detect not only a minute foreign matter but also a large foreign matter of a thin-film shape which spreads over a range of several μm without overlooking it. Since the detected image signal from the thin-film shaped foreign matter does not always become great, however, the S/N ratio is low in the detected image signal of one pixel unit and overlooking can occur. Therefore, the SN ratio is improved by cutting out an image with a unit of n×n pixels corresponding to the size of the thin-film shaped foreign matter and conducting convolution computation.

The inspection-area processor portions 1308a to 1308n will now be described. The inspection-area processor portions 1308a to 1308n are used when data in a region where inspection is not necessary (including a region in the chip) should be removed, the detection sensitivity should be changed in every region (including a region in the chip), or an inspection region should be selected in regard to a foreign matter detection signal or a defect detection signal obtained from the foreign-matter detection processor circuits 1307a to 1307n by specifying a chip.

For example, if the detection sensitivity is permitted to be low for a region among regions on the inspection object substrate 1, then the inspection-area processor portions 1308a to 1308n may set the threshold-value for the region obtained from the threshold-value calculation processor portion 1303 to be a high value. Or it is possible to use a method of leaving only data of a foreign matter in a region to be inspected from data of foreign matters which are output from the foreign-matter detection processor circuits 1307a to 1307n on the basis of coordinates of the foreign matter.

Here, the detection sensitivity is lowered, for example, for a low density region of circuit pattern in the inspection object substrate 1. In a high density region of circuit pattern, the yield of the device production can be improved by high sensitivity inspection.

If all regions on the inspection object substrate 1 are inspected with the same sensitivity, however, important foreign matters cannot be extracted easily because important foreign matters and unimportant foreign matters are mixed. Therefore, the inspection-area processor portions 1308a to 1308n can extract important foreign matters efficiently by lowering the detection sensitivity in a region which does not exert great influence upon the yield such as a region where a circuit pattern does not exist according to CAD information or threshold-value map information in the chip. However, the method for extracting a foreign matter is not limited to the method for changing the detection sensitivity, but an important foreign matter may be extracted by classifying foreign matters as described later, or an important foreign matter may be extracted on the basis of the foreign matter size.

The characteristic-quantity calculator circuit 1309 will now be described. This characteristic quantities are values which represent features of a detected foreign matter or defect, and the characteristic-quantity calculator circuit 1309 is a processing circuit for calculating the aforementioned characteristic quantities. As the characteristic quantities, there are, for example, the amount of reflected/diffracted light (amount of scattered light) from a foreign matter or a defect which is obtained at high angle illumination or low angle illumination while illumination angles α, β and γ are changed, the number of detection pixels, the shape or the direction of the principal axis of inertia of the region where a foreign matter is detected, a position where a foreign matter is detected on the wafer, a type of underlying circuit pattern, and threshold-values at the time of detection of a foreign matter.

The integration processor portion 1310 will now be described. The integration processor portion 1310 has functions of unifying results of foreign matter detection subjected to parallel processing in the pixel merge circuits 1305 and 1306, unifying characteristic quantities calculated by the characteristic-quantity calculator circuit 1309 and the foreign matter detection results (position information of the foreign matter or the defect), and sending results to the total controller portion 50. It is desirable to conduct the inspection result unification processing on a PC or the like to facilitate change of processing contents.

On the other hand, an image signal of luminous spots of a reflected/diffracted light image from a repetitive pattern formed on the wafer 1 at an imaging position of a Fourier transform image of the detection optic system 20 picked up by the TV camera 92 is sent to the signal processing system 95. There are an A/D converter, an image data processing portion, and a pattern pitch computation portion in the signal processing system 95. The image signal of the luminous spots of the reflected/diffracted light image from the repetitive pattern is subject to conversion, and then processed in the image data processing portion as image data, and a pitch of the luminous spots of the reflected/diffracted light image is found in the pattern pitch computation portion. Data of the pitch of the luminous spots thus found and image data are sent to the total controller portion 50, and sent to a spatial filter control portion 27 as a signal which controls the arrangement pitch of the shield plate of the spatial filter 22. Moreover, when the mirror 240 is inserted between the object lens 21 and the imaging lens 23, the spatial filter is saved.

### Embodiment 4

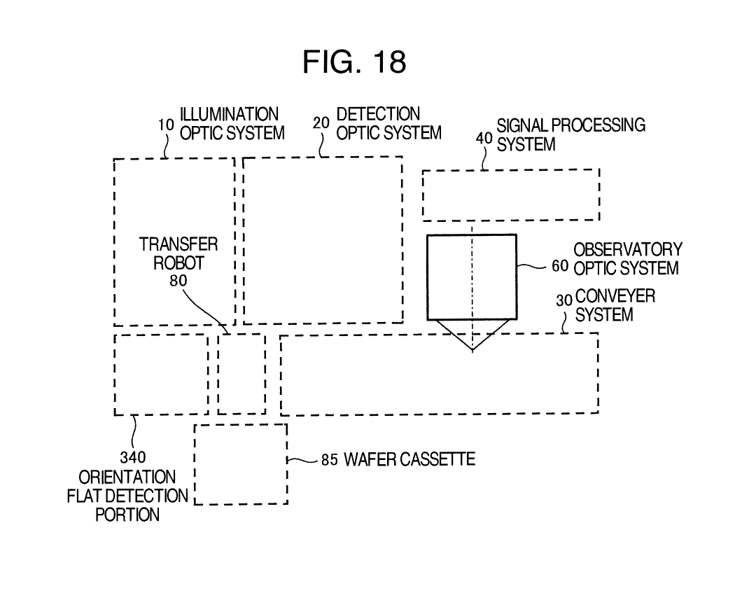

An embodiment in which a microscope is attached to the defect inspection apparatus is shown in FIG. 18. This embodiment has a configuration in which a foreign matter detected by the inspection can be ascertained with the observatory optic system 60. A detected contaminant on the wafer (including a false report as well) is moved to a position of a field of view of the microscope in the observatory optic system by moving the stages 31 and 32, and the image is observed with the observatory optic system 60.

An advantage of having the observatory optic system 60 is that the detected foreign matter can be observed instantly without moving the wafer to a review device such as an SEM. A cause of generation of a foreign matter can be identified quickly by instantly observing a matter detected by the inspection apparatus. Furthermore, as for the image of the TV camera 64 in the observatory optic system 60, an image of a detected foreign matter is displayed on a color monitor shared by a personal computer, and a partial inspection can be conducted around coordinates of the detected foreign matter using laser irradiation and stage scanning. The observatory optic system 60 also has functions of marking a scattered light image of the foreign matter and the foreign matter position and displaying them on the monitor. As a result, it is also possible to confirm whether a foreign matter has been detected actually. Moreover, as for a partial image obtained by stage scanning, an inspection image of a die adjacent to a die on which a foreign matter has been detected can also be acquired, and consequently comparison and confirmation on the spot is also possible.

As for the observatory optic system 60, visible light (for example, white light) may be used as its light source, or a microscope using an ultraviolet light source as the light source may be used. Especially for observing minute foreign matters, a microscope having a high resolution such as, for example, a microscope using ultraviolet light is desirable. If a microscope of visible light is used, there is an advantage that color information of foreign matters is obtained and recognition of foreign matters can be conducted easily.

### REFERENCE SIGNS LIST

1: Wafer (inspection object substrate)
10: Illumination optic system
11: Laser light source
20: Detection optic system
25: Optical filter
30: Conveyer system
35: Drive circuit
40: Signal processing system
50: Total controller portion
51: Input/output means
52: Display means
53: Memory portion
60: Observatory optic system
70: Pupil observatory optic system
80: Transfer robot
82: Transfer arm
155: Reverse inspection device
180: Photodetection means
195: Foreign matter removal means
240, 320: Optical elements
300: End face inspection device
350: Orientation flat detection optic system
1301: A/D converter
1302: Data memory portion
1303: Threshold-value calculation processor portion
1307: Foreign-matter detection processor circuit
1308: Inspection-area processor portion
1309: Characteristic-quantity calculator circuit
1310: Integration processor portion
1311: Result display portion

1. An optical inspection apparatus comprising:
a conveyer system for mounting thereon and moving a substrate;
an illumination optic system for irradiating said substrate with laser light;
a detection optic system for detecting light scattered by a defect on said substrate;
an optical element disposed on an optical path of said laser light; and
a movement portion for moving said optical element one-dimensionally or two-dimensionally.

2. The optical inspection apparatus according to claim 1, wherein said movement portion comprises:
a first holder for holding said optical element, or a first optical unit having said optical element provided therein;
a motor;
a feed screw; and
a linear guide.

3. The optical inspection apparatus according to claim 1, wherein said optical element is an optical element having a planar shape.

4. The optical inspection apparatus according to claim 1, wherein said optical element is at least one of a beam splitter, a mirror, an ND filter, and a polarizer.

5. The optical inspection apparatus according to claim 2, comprising a second holder or a second optical unit,
wherein
moving on said linear guide by said motor and said feed screw, and
changeover between the first holder or the first optical unit and said second holder or said second optical unit is conducted.

6. An optical inspection apparatus comprising:
a conveyer system for mounting thereon and moving a substrate;
an illumination optic system for irradiating said substrate with laser light;
a photodetection portion for measuring an illumination state of said laser light;
a detection optic system for detecting light scattered by a defect on said substrate;
an optical element disposed on an optical path of said laser light; and
a movement portion for moving said optical element one-dimensionally or two-dimensionally,
wherein said movement portion moves said optical element according to said illumination state.

7. An optical inspection apparatus comprising:
a conveyer system for mounting thereon and moving a substrate;
an illumination optic system for irradiating said substrate with laser light;
a detection optic system for detecting light scattered by a defect on said substrate; and
a photodetection portion for detecting a shape of said laser light.

8. The optical inspection apparatus according to claim 7, wherein
said photodetection portion is provided in a portion of said conveyer system where said substrate is placed, and
said photodetection portion can be moved in a ø direction, an α direction, and a z direction.

9. The optical inspection apparatus according to claim 7, comprising:
a memory portion; and
a control portion,
wherein
said memory portion stores a first shape of said laser light in advance, and
said control portion collates said first shape with a second shape of said laser light detected by said photodetection portion.

10. The optical inspection apparatus according to claim 7, comprising:
a lens; and
a movement portion for moving said lens,
wherein a shape of said laser light is adjusted by movement of said lens.

11. An optical inspection apparatus comprising:
a conveyer system for mounting thereon and moving a substrate;
an illumination optic system for irradiating said substrate with laser light;
a detection optic system for detecting light scattered by a defect on said substrate;
a plurality of lenses; and
a first optical element and an image pickup device disposed on an optical path behind said plurality of lenses to measure parallelism of said laser.

12. The optical inspection apparatus according to claim 11, wherein
said plurality of lenses comprise:
a first lens;
a second lens;
a guide;
a motor; and
a feed screw,
wherein said first lens is fixed to the guide, and
said second lens is moved along said guide by said motor and the feed screw.

13. The optical inspection apparatus according to claim 11, wherein said first optical element is wedge-shaped plane glass.

14. The optical inspection apparatus according to claim 11, wherein said image pickup device is a TV camera.

15. The optical inspection apparatus according to claim 11, comprising a control portion,
wherein said control portion calculates a first waveform and a second waveform of said laser light from an image detected by said image pickup device, calculates a phase difference between said first waveform and said second waveform, and adjusts spacings between said plurality of lenses using said phase difference.

16. A method of moving an optical element in an optical inspection apparatus comprising:
measuring an illumination state of an illumination optic system; and
moving an optical element according to said illumination state.

17. A method of correcting a detection optic system comprising:
observing a shape of a laser spot detected at an imaging position of the detection optic system; and
moving a lens on an object point side of said detection optic system according to the shape of said laser spot.

18. A method of correcting a detection optic system comprising:
moving laser light focused at an object point position;
finding intensity distribution at an imaging position of the detection optic system;
comparing data stored in advance; and
correcting a sensitivity of a sensor in the detection optic system.

19. An optical inspection apparatus comprising:
a conveyer system for mounting thereon and moving a substrate;
an illumination optic system for irradiating said substrate with laser light;
a detection optic system for detecting light scattered by a defect on said substrate;
a condenser lens for focusing said laser light at an object point of said detection optic system;
a stage for moving said condenser lens; and
an image pickup device disposed to be movable at an imaging position of said detection optic system.

20. The optical inspection apparatus according to claim 19, comprising:
a mirror disposed before an optical path of said condenser lens; and
a movement portion for moving said mirror,
wherein
said condenser lens and said mirror are moved together with said image pickup device to calculate intensity distribution,
said intensity distribution is compared with data stored in advance, and
a sensitivity of said detection optic system is corrected.

21. An optical inspection apparatus comprising:
a conveyer system for mounting thereon and moving a substrate;
an illumination optic system for irradiating said substrate with laser light;
a detection optic system for detecting light scattered by a defect on said substrate;
a mirror disposed in said detection optic system;
an image pickup device for receiving light reflected by said mirror;
a condenser lens for focusing said laser light; and
a stage for moving said condenser lens.

22. The optical inspection apparatus according to claim 21, wherein said mirror is a shear plate.

23. The optical inspection apparatus according to claim 21, comprising a control portion,
wherein said control portion moves said stage according to interference fringes projected from said shear plate to said image pickup device.
